(19) United States
(12) Patent Application Publication
(10) Pub. No.: US 2014/0249851 A1
(43) Pub. Date: Sep. 4, 2014

(54) Systems and Methods for Developing and Managing Oncology Treatment Plans

(71) Applicant: ELEKTA AB (PUBL), Stockholm (SE)

(72) Inventors: John Christodouleas, Swarthmore, PA (US); Robert Hubbell, Menlo Part, CA (US); Marjorie Van Der Pas, Mountain View, CA (US); Faye Ann MacDonald, Calgary (CA); Joel Goldwein, Merion Station, PA (US); Randy Norton, Edmonton (CA)

(21) Appl. No.: 13/783,667

(22) Filed: Mar. 4, 2013

(51) Int. Cl. G06F 19/00

(52) U.S. Cl. CPC G06F 19/324
USPC 705/3; 705/2

(57) ABSTRACT

Embodiments of the invention provide systems and methods for managing oncology care plans. The systems and methods involve or include: retrieving a standard care plan from an electronically stored library of oncology care plans provided by one or more clinical content providers; receiving, from a user, a modification to the standard care plan; generating a local care plan that includes the standard care plan and the modification to the standard care plan; retrieving, from the electronically stored library of oncology care plans, an updated standard care plan that includes one or more updates to the standard care plan provided by the one or more clinical content providers; and automatically generating an updated local care plan that includes the updated standard care plan and the modification to the standard care plan.

### TECHNICAL FIELD

This invention relates to systems and methods for treating patients and, in particular, to systems and methods for developing and managing treatment plans for oncology patients.

### BACKGROUND

Increases in the cost of healthcare driven by aging populations and dramatic advances in science and technology are forcing patients, providers, and payers in both developed and developing countries to demand higher value healthcare. While advancing basic science and technology will always be a fundamental approach to improving care, stakeholders are broadening their interests and asking for solutions that enhance healthcare processes, to provide a relatively inexpensive way of improving outcomes and lowering overall treatment costs. More and more, customers are demanding solutions that allow them to standardize and track clinically and financially important decisions.

The financial pressures and the resulting drive for process improvement are especially intense in oncology. Oncologists and oncology administrators face ongoing and increasing pressure to standardize patient care so that they can offer high quality care in an efficient manner. For example, oncologists must keep costs down, without sacrificing safety, as they compete to attract patients and receive maximum reimbursement for services. At the same time, the science of oncology is expanding at a faster pace than ever before. The number of scientific publications has gone up ten-fold in the last decade, compared to the previous decade, which makes it difficult for healthcare providers to stay informed of the latest technological advances.

In many settings, healthcare professionals are offered access to general enterprise-wide health information systems (HIS) for collecting and processing data, and managing health services. Although these systems may be inexpensive or cost-free for oncology departments to utilize, existing HISs lack oncology-specific functionality. As a result, oncologists and oncology departments are presently limited in their ability to access the information they need to minimize costs and improve overall patient care.

There is a need for systems and methods that improve the overall care process for oncology patients. In particular, needs exist for systems and methods for developing and managing care plans for oncology patients, based on oncology-specific guidelines and functionality.

### SUMMARY OF THE INVENTION

In certain embodiments, systems and methods described herein provide oncology-specific functionality and information that improve the quality of care and reduce costs for oncology patients and providers. The systems and methods are suitable for use by, for example, local oncology departments, individual physicians, regional and provincial networks, and/or accountable care organizations. While the systems and methods are needed and broadly applicable in any geographic location and any oncology application, the systems and methods are particularly needed in new and emerging markets, such as China, Africa, and Latin America, where clinicians generally have less formal training than their counterparts in North America and Europe. For example, where formal training is less accessible, clinicians may be able to deploy advanced technologies and protocols more rapidly with the systems and methods described herein. In some embodiments, oncology-specific content (e.g., care plans and decision trees, a combination also referred to as pathways) is provided by reputable, clinical guideline organizations in specific geographic regions (e.g., Africa). Clinicians may be provided with clinical decision support on appropriate staging, treatment and follow up based on available medical technology. In general, the systems and methods may be used to immediately and broadly improve the care of cancer patients.

The systems and methods described herein have broad applicability for workers and patients in the field of oncology. Users of the systems and methods may include, for example, the oncology community in the United States, such as U.S. medical oncologists and U.S. radiation oncologists. Oncologists in other countries may also be attracted to the systems and methods. For example, many oncologists in developed countries with national health services have been asked by their government to demonstrate that they deliver standardized care. In developed countries, where oncologists already receive excellent training, the clinical pathways may be recommended and/or supplied by standards groups in the country, preferably in the local language. In the developing or under developed world, where there is less oncology training and fewer oncologists per cancer patient, the systems and methods described herein may improve the safety of cancer care while at the same time augmenting the education of oncologists who use the systems and methods.

The systems and methods also benefit practice administrators and managers who benefit from having the staff deliver more uniform clinical care for the majority of patients. Reducing clinical variation generally allows more time for the staff to support and educate patients, and to focus more attention on complex patients who may need treatment “off pathway.” Administrators may be able to better protect the practice from liability issues by being able to point to the structured use of up to date, evidenced-based oncology care. Further, by providing electronic information on benefits coverage or electronic authorization functionality, the billing staff may spend less time on the phone with payers, and the billers and medical staff may spend less time resolving disputed claims.

In one aspect, the invention relates to a system for managing oncology care plans. The system includes memory for storing computer-executable instructions, and a processor for executing the instructions stored in the memory which implements an application. In execution, the application retrieves a standard care plan from an electronically stored library of oncology care plans provided by clinical content providers, and receives a modification to the standard care plan from a user of the application. The application generates a local care plan that includes the standard care plan and the modification to the standard care plan. The application then retrieves an updated standard care plan, from the electronically stored library of oncology care plans, that includes updates to the standard care plan provided by the one or more clinical content providers and automatically generates an updated local care plan that includes the updated standard care plan and the modification to the standard care plan.

In certain embodiments, the modification to the standard care plan includes an addition, a change, and/or a deletion of non-care plan defining attributes of the standard care plan. The modification to the standard care plan may be based on, for example, geographic location, availability of treatment options, and/or a clinical factor. Execution of the instructions may implement the application for activating the updated local care plan.

In some embodiments, the application retrieves an electronic medical record (EMR) from a data storage server which may include information about a patient's clinical presentation, and automatically identifies the updated local care plan as being a suitable care plan for the patient based on the patient's clinical presentation. The application may also select the updated local care plan for treating the patient and determine a pathway adherence for the updated local care plan. The pathway adherence represents a correlation between the updated local care plan and an opinion from an expert regarding an appropriate treatment for the patient.

In one embodiment, the application determines a pathway deviation for the patient. The pathway deviation represents a correlation between the updated local care plan and an actual treatment given to the patient. The application may also update the EMR with data from the updated local care plan.

In various embodiments, the application automatically compares standard care plans provided by at least two clinical content providers and creates a single standard care plan from the standard care plans that share matching care plan-defining attributes. The single standard care plan includes identification numbers from the at least two clinical content providers. The application may also amend the library of oncology care plans with one care plan based on the updated local care plan.

In another aspect, the invention relates to a method of managing oncology care plans. The method includes retrieving a standard care plan from an electronically stored library of oncology care plans provided by clinical content providers and receiving, from a user, a modification to the standard care plan. Based on the standard care plan and the modification to the standard care plan, the application generates a local care plan. An updated standard care plan is retrieved from the electronically stored library of oncology care plans that includes updates to the standard care plan provided by the clinical content providers, and an updated local care plan is automatically generated, which includes the updated standard care plan and the modification to the standard care plan.

In certain embodiments, the modification to the standard care plan includes an addition, a change, or a deletion of attributes of the standard care plan. The modification to the standard care plan may be based on, for example, geographic location, availability of treatment options, and/or a clinical factor. The method may also include activating the updated local care plan.

In various embodiments, the method also includes retrieving an electronic medical record (EMR) from a data storage server, the EMR including information about a patient's clinical presentation; and automatically identifying the updated local care plan as being a suitable care plan for the patient, based on the patient's clinical presentation. The method may also include selecting the updated local care plan for treating the patient; and determining a pathway adherence for the updated local care plan. The pathway adherence represents a correlation between the updated local care plan and an opinion from an expert regarding an appropriate treatment for the patient.

In certain embodiments, the method also includes determining a pathway deviation for the patient. The pathway deviation represents a correlation between the updated local care plan and an actual treatment given to the patient. The EMR may, in some cases, be updated with data from the updated local care plan. The method may also include automatically comparing standard care plans provided by at least two clinical content providers and creating a single standard care plan from at least two standard care plans that share matching care plan-defining attributes. The single standard care plan includes identification numbers from the at least two clinical content providers. In one embodiment, the method includes amending the library of oncology care plans with one care plan based on the updated local care plan.

The foregoing and other objects, features and advantages of the present invention disclosed herein, as well as the invention itself, will be more fully understood from the following description of preferred embodiments and claims, when read together with the accompanying drawings. In the drawings, like reference characters generally refer to the same parts throughout the different views. The drawings are not necessarily to scale, emphasis instead generally being placed upon illustrating the principles of the invention.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

While the invention is particularly shown and described herein with reference to specific examples and specific embodiments, it should be understood by those skilled in the art that various changes in form and detail may be made therein without departing from the spirit and scope of the invention.

FIG. 1 is a schematic diagram of a system for generating and managing care plans for oncology patients, in accordance with certain embodiments of the invention.

FIG. 2 is a screenshot of data for an oncology patient, in accordance with certain embodiments of the invention.

FIG. 3 is a screenshot of information utilized and generated by a clinical decision support system, in accordance with certain embodiments of the invention.

FIG. 4 is a schematic diagram of a decision tree utilized by the clinical decision support system, in accordance with certain embodiments of the invention.

FIG. 5 is a schematic diagram showing the generation of a local care plan from a standard care plan using a local care plan management system, in accordance with certain embodiments of the invention.

### DETAILED DESCRIPTION

It is contemplated that devices, systems, methods, and processes of the claimed invention encompass variations and adaptations developed using information from the embodiments described herein. Adaptation and/or modification of the devices, systems, methods, and processes described herein may be performed by those of ordinary skill in the relevant art.

Throughout the description, where devices and systems are described as having, including, or comprising specific components, or where processes and methods are described as having, including, or comprising specific steps, it is contemplated that, additionally, there are devices and systems of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

In general, clinical pathways include detailed methods for identifying appropriate care plans or treatment regimens for cancer patients, according to specific patient presentations, including the stage and state of disease. The clinical pathways may be or include, for example, decision trees that process information about a patient (e.g., from an electronic medical record) to determine an appropriate path through the tree and arrive and a desirable care plan. As a result of the decision-making in the clinical pathway, a treatment plan for the patient may be specified, including dosing levels for particular drugs, radiotherapy, and/or a schedule for administration.

In certain embodiments, the systems and methods described herein provide evidence-based clinical pathways along with basic clinical decision support to identify care plans that match a patient's clinical presentation. The clinical pathways may provide, for example, efficient selection and ordering for eighty percent or more of oncology patients. In general, the standardized care afforded by these systems and methods provides oncologists and other caregivers more time to evaluate and care for patients who need more individualized or complex care. The systems and methods promote efficient and evidence-based cancer care.

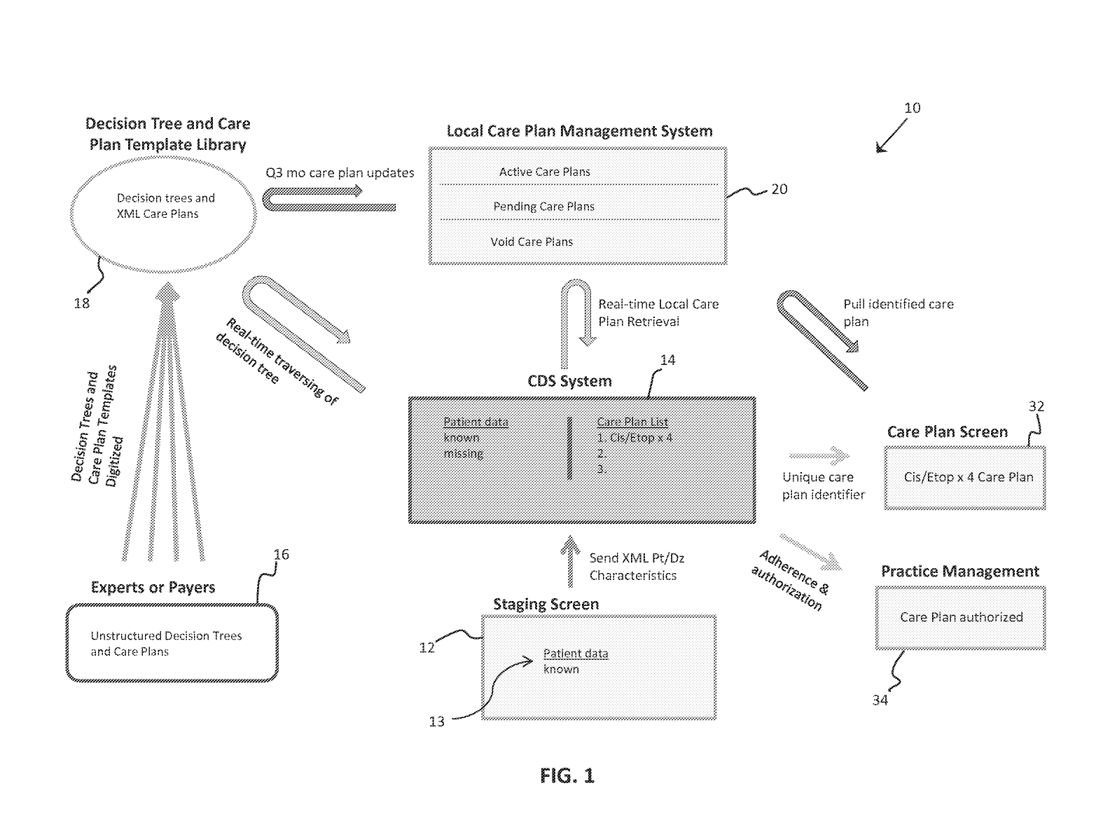

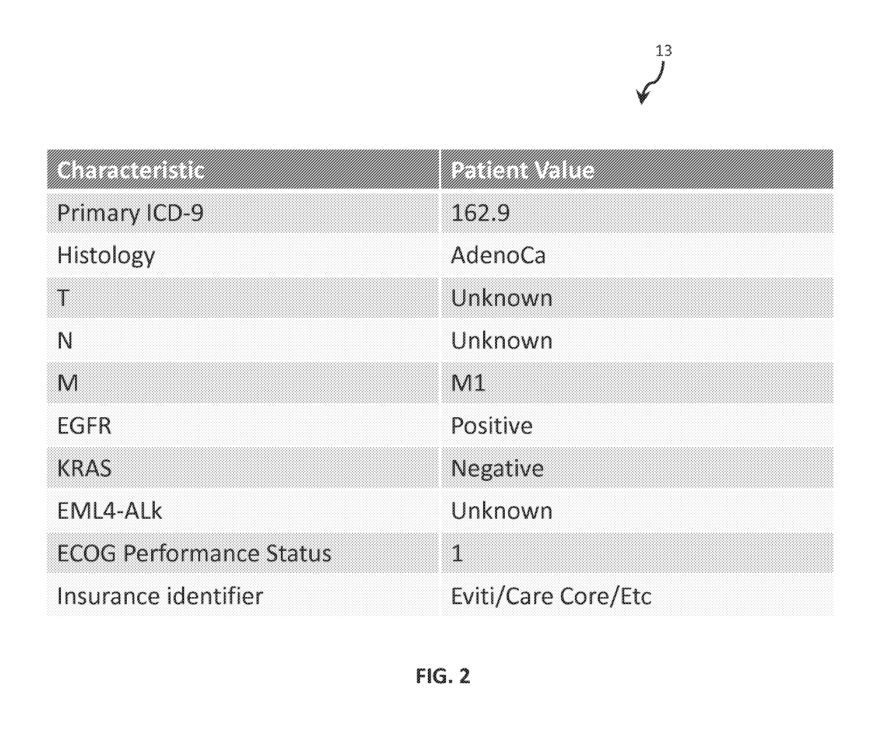

Referring to FIG. 1, a system 10 is provided for facilitating the treatment of oncology patients. The system 10 includes a staging screen or display 12 where patient data 13 is presented. Referring also to FIG. 2, the patient data 13 may include, for example, disease characteristics and/or personal information (e.g., age and gender) for a patient. The patient data 13 may be stored in an electronic medical record (EMR) and transferred (e.g., in an XML format) from the staging screen 12 to a clinical decision support (CDS) system 14, which analyzes the patient data 13 to identify appropriate treatment or care plans for the patient. A clinician or doctor utilizing the system 10 may then select one of the available care plans, and the patient may go on to receive treatment in accordance with the selected care plan.

Still referring to FIG. 1, the available care plans in the CDS system 14 preferably originate from one or more clinical content providers 16 (e.g., oncology experts) and are electronically stored in a database or library 18 of oncology care plans. The clinical content providers 16 develop and make available standard care plans and associated decision trees for oncology patients. The standard care plans and decision trees are electronically stored (e.g., in XML format) in the library 18 of oncology care plans.

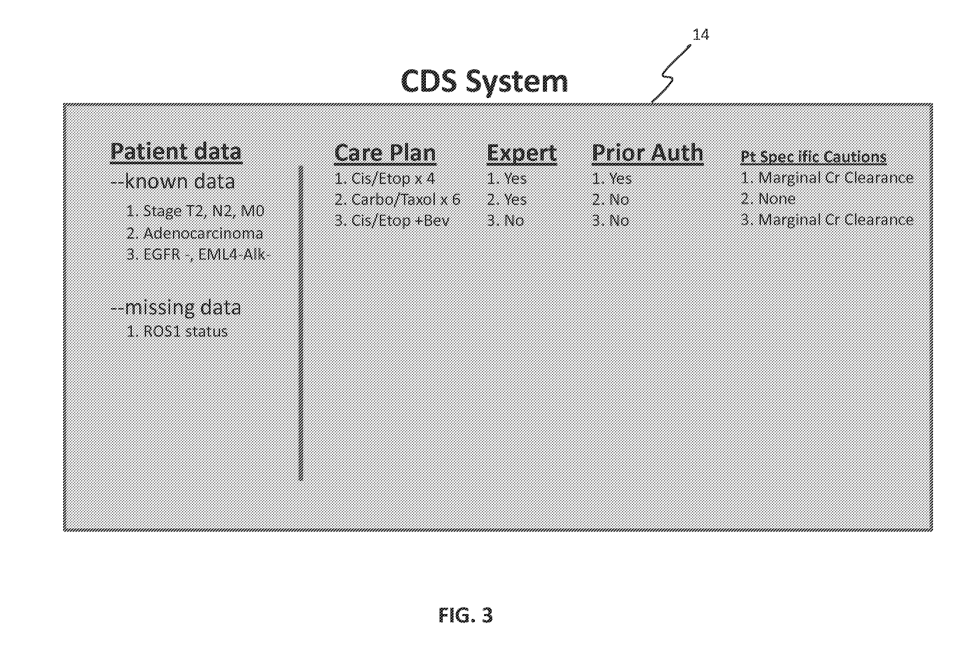

In various embodiments, a local care plan management (LCPM) system 20, residing at or utilized by a local oncology department, may access and retrieve the standard care plans from the library 18. The retrieved care plans are preferably categorized in the LCPM system 20 according to whether the care plans are void (i.e., not approved for use), pending (i.e., approval for use is pending), or active (i.e., approved for use). Referring to FIG. 3, the CDS system 14 is configured to access active care plans from the LCPM system 20 and recommend one or more active care plans for patients, according to the patient data 13.

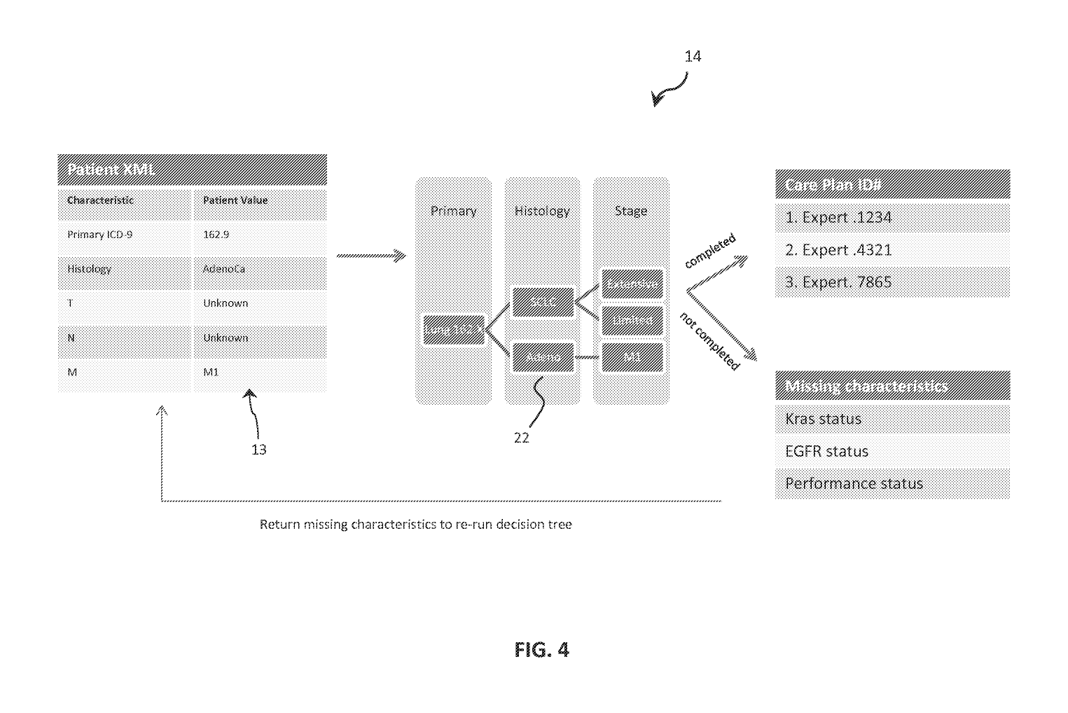

In general, referring to FIG. 4, the CDS system 14 may utilize one or more decision trees 22 to recommend appropriate active care plans for patients. For example, if a patient has a particular type of cancer (e.g., lung cancer), the decision tree 22 may reject care plans associated with other types of cancer and consider only those care plans that are associated with the patient's particular type of cancer. The CDS system 14 may further navigate through the decision trees 22 using additional patient data (e.g., age, gender, stage, insurance plan, payer information) to identify the most appropriate care plan, among all of the care plans that are generally suitable for the patient's particular type of cancer. At each branch of a decision tree 22, the CDS system 14 may choose a pathway along the decision tree 22 according to the patient data 13 and particular requirements associated with the pathway. If the decision tree 22 has insufficient information to arrive at a recommendation, the CDS system 14 may request additional information (e.g., additional patient data) from a user (e.g., a clinician) of the CDS system 14.

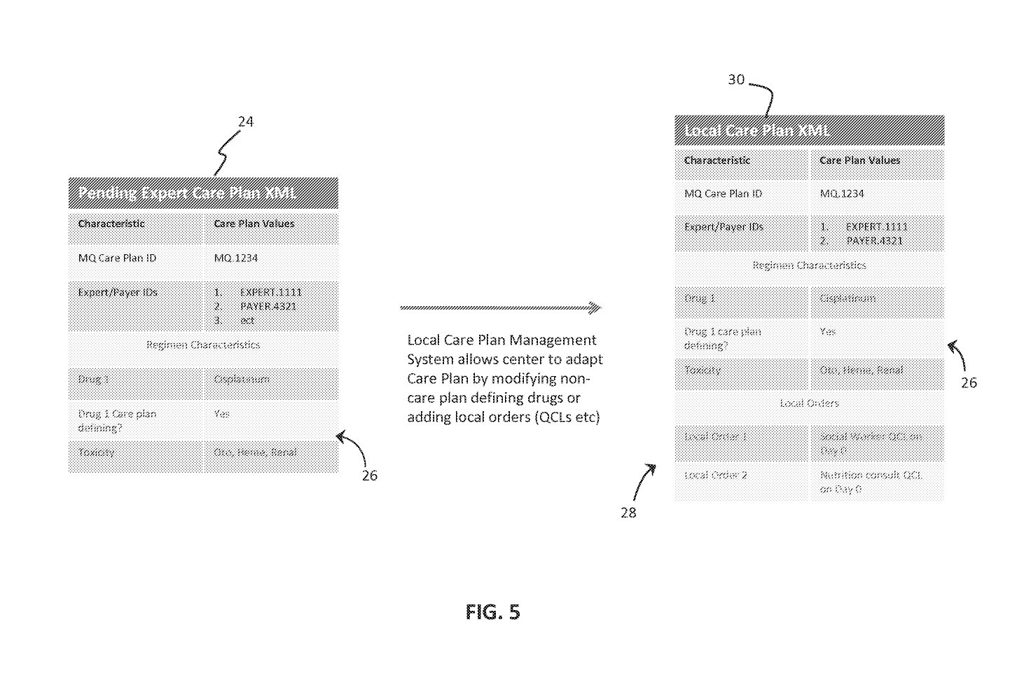

In various embodiments, the LCPM system 20 allows a local oncology department (e.g., a point of care location at a particular hospital in a particular country) to customize the standard care plans received from the library 18. For example, referring to FIG. 5, a standard care plan 24 may include regimen characteristics 26 that define treatment steps or orders, such as specific drugs to be delivered to a patient. The standard care plan 24, however, may lack particular steps or orders that the local oncology department wishes to include as part of the overall care plan. Accordingly, the local care plan management system allows the local oncology department to amend or modify the standard care plans according to the local oncology department's preferences. For example, the local oncology department may add one or more local orders 28 to the standard care plan 24. The local orders 28 may include any additional steps that the local oncology department wishes to add to the standard care plan 24. For example, the local orders 28 may require a patient to visit a social worker and/or a nutrition consultant. The local oncology department may also modify or remove certain features of the standard plan 24, such as features associated with non-care plan defining drugs. In general, the modification may be based on geographic location, availability of treatment options, and/or a clinical factor. The standard care plan plus the modification provided by the local oncology department together form what is referred to herein as a local care plan 30.

In some embodiments, the system 10 allows the local oncology department to modify only non-pathway defining attributes or orders (e.g., non-care plan defining drugs). This way, the critical, pathway defining features (e.g., the regimen characteristics 26) specified by the clinical content providers may be preserved within the local care plan 30.

In certain embodiments, the LCPM system 20 is configured to automatically access the oncology care plan library 18 to receive updates to the standard care plans and/or decision trees provided by the clinical content providers. For example, the LCPM system 20 may be configured to retrieve updates from the library periodically (e.g., every three months) and/or when a notification is received that an update is available. After retrieving an updated standard care plan, the LCPM system 20 may automatically combine the updated standard care plan with an existing modification that was previously provided for the corresponding original (i.e., non-updated) standard care plan. As a result, the LCPM system 20 is able to automatically customize the updated standard care plans, as they are received, with existing modifications created by the local oncology department for corresponding previous standard care plans. An updated standard care plan plus a modification is referred to herein as an updated local care plan. The updated local care plan may be automatically stored in the library 18.

In general, the LCPM system 20 provides a tool for comparing active local care plan parameters side-by-side with the updated standard care plan parameters, allowing users of the system 10 to quickly and efficiently generate updated local care plans. The comparison may highlight the parameters that are care plan-defining and the parameters that are different between the active local care plan and the standard care plan. Users are preferably able to select and edit single or multiple fields for the care plans, while updating only the pathway-defining variables.

Referring again to FIG. 1, in various embodiments, the CDS system 14 is configured to directly access standard care plans from the library, without necessarily retrieving care plans from the LCPM system 20. For example, the CDS system 14 may utilize the patient data 13 to identify standard care plans within the library 18 that are appropriate for particular patients. In such instances, the decision trees in the library 18 may be used by the CDS system 14 to identify appropriate standard care plans, based on the patient data 13.

In alternative embodiments, the decision trees provided by the clinical content providers are not stored in the library 18 but are, instead, stored or directly managed by the clinical content providers. In such instances, the system 10 may include multiple CDS systems that access the decision trees managed by the clinical content providers. For example, the system 10 may include one dedicated CDS system for each clinical content provider. Like the CDS system 14, the dedicated CDS systems utilize patient data and decision trees to identify appropriate standard care plans. The output from the dedicated CDS systems may be care plan identification numbers. The system 10 may then use these identification numbers to retrieve the care plan information associated with the identification numbers from the library 18.

When the CDS system 14 has identified one or more appropriate care plans for the patient (e.g., an active care plan in the LCPM system 20), a clinician (e.g., doctor) utilizing the system may select one particular care plan from the list of appropriate care plans. In certain embodiments, the clinician's selection is then presented in detail on a display or care plan screen 32. Details of the selection may include, for example, a unique care plan identifier and a list of specific treatment steps a patient should receive, including treatment with pathway-defining drugs and performance of local orders. Once a selection has been made, the system 10 may update the patient's EMR with data from the selected care plan.

In certain instances, the LCPM system 20 may identify two or more identical care plans that share the same care plan defining properties and were provided by more than one clinical content provider. In such an instance, the LCPM system 20 may combine the identical care plans into a single care plan that includes the care plan defining parameters and care plan identification numbers from the clinical content providers.

The CDS system 14 preferably includes or utilizes a set of decision trees 22 and other tools for clinical decision support that provide clinicians with patient-specific guidance on work-up, treatment and follow-up at the point of care. For example, a set of work-up decision trees may provide work-up guidance, for example, to aid the ordering of appropriate staging laboratory and imaging studies. Likewise, a set of treatment decision trees may provide treatment guidance to allow clinicians to select from one or more evidence-based care plans covered by the patient's payer. For medical oncologists, the care plans may include information on all aspects of the oncologic intervention, including the oncology drugs, ancillary medications, laboratory studies, and timing of these orders. For radiation oncologists, the treatment clinical decision support may include simulation, treatment planning, and treatment delivery guidance and orders. In one embodiment, a set of follow-up decision trees provides follow-up guidance to facilitate the ordering of appropriate surveillance evaluations and survivorship interventions at appropriate intervals. The CDS system 14 is preferably flexible, for example, to allow clinicians to deviate from recommended guidelines and document their rationale, as necessary, for the best care of individual patients.

In various embodiments, the clinical content (e.g., standard care plans and decision trees) accessed by the CDS system 14 is provided and maintained by one or more independent clinical guideline organizations, such as the National Comprehensive Cancer Network (NCCN). In general, these organizations develop and/or provide oncology-specific guidelines, which may be available to customers by subscription. For example, customers may license guidelines or pathways content from one or more of these organizations.

Numerous public and private guideline organizations also offer region-sensitive clinical content, since oncology standards should reflect economic and cultural practicalities. For example, the treatment guidelines for a practice in central London may differ from those for a practice in New Delhi. Accordingly, embodiments of the CDS system 14 include an interface or interoperability standard that is open to global and regional clinical content. Large oncology organizations with networks of treatment sites may also choose to create their own digitized clinical guidelines and distribute them via the CDS system 14.

In various embodiments, the system includes a practice management module 34 that is configured to evaluate and track the performance of the clinicians and local oncology departments that utilize the system 10. For example, after a clinician has selected a particular care plan from a list of care plans in the LCPM system 20, the system 10 may record an adherence score associated with the clinician's selection. In general, the adherence score is a measure of how well the selection correlates with recommendations provided by one or more experts (e.g., the clinical content providers). When tracked over time, a high adherence score for the clinician (or a local oncology department) may indicate that the clinician generally selects care plans that are consistent with the expert recommendations. In one embodiment, dashboards are created for calculating adherence. The dashboards may be grouped, for example, by provider, department, source of pathway content, disease, and/or treatment.

The system may also utilize or include a set of rules that require non-adherence to be detected and/or documented (e.g., when a patient is treated with a regimen that differs from recommendations). The documentation is preferably captured in discrete fields to support reporting and analysis.

The practice management module 34 may also be configured to track pathway deviation for clinicians and/or local oncology departments. Pathway deviation is generally a measure of how well a treatment regimen received by a patient agrees with the corresponding care plan initially selected by the clinician. For example, if a patient goes on to receive treatment that deviates considerably from the selected care plan, the pathway deviation would be high. Conversely, if the patient receives treatment that is consistent with the selected care plan, the pathway deviation would be low. By recording pathway deviation for treatment regimens, the ability or tendency of clinicians and/or local oncology departments to stick with the selected care plan may be tracked over time.

In general, the systems and methods described herein provide value for all key oncology stakeholders. For example, patients benefit from being cared for in controlled systems that facilitate access to the most up-to-date and evidence-based clinical pathways. All care settings may also be improved, for example, from specialized centers in Canada to general practices in Brazil. Moreover, economic efficiencies conferred by the systems and methods may control costs for oncologists and patients, thereby providing welcome relief for patients world-wide.

Advantageously, the systems and methods described herein allow physicians, physicists, nurses, dosimetrists, and therapists to work more efficiently by spending less time identifying best-practices for individual patients, inputting orders, and arguing for payment. In addition, these clinicians, especially in emerging markets where formal training is less accessible, may be able to deploy advanced technologies and protocols more rapidly when the advancements are sanctioned by reputable clinical guideline organizations and provided with guidance on appropriate use.

Researchers may also benefit from an increased use of structured data within the clinical workflow which can be easily retrieved from one or more back-end registries. In addition, the decreased variability in treatment and outcomes associated with the CDS system 14 may make it easier to identify novel technologies or processes that result in improved care.

As a further advantage, payers may be able to provide a higher value insurance product to their own customers by partnering with centers that use the systems and methods described herein. Such partnering may be true for traditional public and private payers around the world and alternative payment models such as Accountable Care Organizations developing in the United States. For payers, the systems and methods may provide standard metrics and offer an opportunity to incorporate the payers' own metrics that ensure quality of care. In addition, the systems and methods may decrease the unpredictability of treatment costs, thereby allowing payers to make their own internal business processes more efficient.

In general, the systems and methods provide or utilize a patient information management system that centralizes oncology patient data into a single user interface. The user interface may be accessible by multi-disciplinary teams across multiple locations. Users are preferably able to import and/or export care plans into the information management system. The care plans may have attributes of diagnosis, morphology, stage, intent of treatment, and/or sequence of treatment (e.g., within 30 days of definitive surgery), so that a list of care plans may be limited to match the patient's clinical presentation.

In various embodiments, the systems and methods described herein are implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MAC OS operating system from Apple Computer of Cupertino, Calif., and various varieties of Unix, such as SUN SOLARIS from SUN MICROSYSTEMS, and GNU/Linux from RED HAT, INC. of Durham, N.C. (and others). The systems and methods may also be implemented on such hardware devices as a smart or dumb terminal, a point of sale device (POS), network computer, set top box, game player, mobile device, wireless device, wireless telephone, smartphone, personal digital assistant, media (e.g., music and/or video) player, camera, information appliance, workstation, minicomputer, mainframe computer, or any other device with computing functionality. A general purpose computer or a special purpose hardware device may be utilized.

A communications network may be used to connect components of the system 10. The communication may take place via any media such as standard telephone lines, cell phone networks, LAN or WAN links (e.g., T1, T3, 56 kb, X.25), broadband connections (ISDN, Frame Relay, ATM), wireless links (802.11, Bluetooth, cellular, etc.), and so on, in any suitable combination. Non-limiting examples of networks that can serve as or be part of the communications network include a wireless or wired Ethernet-based intranet, a local or wide-area network (LAN or WAN), and/or the global communications network known as the Internet, which may accommodate many different communications media and protocols.

Those skilled in the art will appreciate that various implementations of the invention may be practiced with various computer system configurations, including hand-held wireless devices such as mobile phones or personal digital assistants (PDAs), multiprocessor systems, microprocessor-based or programmable consumer electronics, minicomputers, mainframe computers, and the like.

The invention may also be practiced in distributed computing environments where tasks are performed by remote processing devices that are linked through a communications network. In a distributed computing environment, program modules may be located in both local and remote computer storage media including memory storage devices.

In some cases, relational (or other structured) databases may provide data storage and management functionality, for example as a database management system or a database server which stores data (e.g., care plans and/or decision trees) related to the services and consumers utilizing the service. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

Computers typically include a variety of computer readable media that can form part of a system memory and be read by a processing unit. By way of example, and not limitation, computer readable media may include computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, or another operating system of platform.

At a minimum, the memory includes at least one set of instructions that is either permanently or temporarily stored. The processor executes the instructions that are stored in order to process data. The set of instructions may include various instructions that perform a particular task or tasks. Such a set of instructions for performing a particular task may be characterized as a program, software program, software, engine, module, component, mechanism, or tool.

The system 10 may include a plurality of software processing modules stored in a memory as described above and executed on the computer. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, RUM and/or JavaScript, for example. Further, it is not necessary that a single type of instruction or programming language be utilized in conjunction with the operation of the system and method of the invention. Rather, any number of different programming languages may be utilized as is necessary or desirable.

The computing environment may also include other removable/non-removable, volatile/nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner via, for example, a communications interface. Additionally, it is appreciated that each of the processor and/or memory may be composed of different physical pieces of equipment.

A user may enter commands and information into the computer through one or more user device interfaces that communicate with input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices (not shown) may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Although internal components of the computer are not shown, those of ordinary skill in the art will appreciate that such components and the interconnections are well known. Accordingly, additional details concerning the internal construction of the computer need not be disclosed in connection with the present invention.

While the invention has been particularly shown and described with reference to specific embodiments, it should be understood by those skilled in the area that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A system for managing oncology care plans, the system comprising:
memory for storing computer-executable instructions; and
at least one processor for executing the instructions stored in the memory, wherein execution of the instructions implements an application for:
retrieving a standard care plan from an electronically stored library of oncology care plans provided by one or more clinical content providers;
receiving, from a user, a modification to the standard care plan;
generating a local care plan comprising the standard care plan and the modification to the standard care plan;
retrieving, from the electronically stored library of oncology care plans, an updated standard care plan, the updated standard care plan comprising one or more updates to the standard care plan provided by the one or more clinical content providers; and
automatically generating an updated local care plan, the updated local care plan comprising the updated standard care plan and the modification to the standard care plan.

2. The system of claim 1, wherein the modification to the standard care plan comprises at least one of an addition, a change, or a deletion of one or more non-care plan defining attributes of the standard care plan.

3. The system of claim 1, wherein the modification to the standard care plan is based on at least one of geographic location, availability of treatment options, or a clinical factor.

4. The system of claim 1, wherein execution of the instructions implements the application for activating the updated local care plan.

5. The system of claim 1, wherein execution of the instructions implements the application for:
retrieving an electronic medical record (EMR) from a data storage server, the EMR comprising information about a patient's clinical presentation; and
automatically identifying the updated local care plan as being a suitable care plan for the patient, based on the patient's clinical presentation.

6. The system of claim 5, wherein execution of the instructions implements the application for:
selecting the updated local care plan for treating the patient; and
determining a pathway adherence for the updated local care plan, the pathway adherence representing a correlation between the updated local care plan and an opinion from an expert regarding an appropriate treatment for the patient.

7. The system of claim 5, wherein execution of the instructions implements the application for determining a pathway deviation for the patient, the pathway deviation representing a correlation between the updated local care plan and an actual treatment given to the patient.

8. The system of claim 5, wherein execution of the instructions implements the application for updating the EMR with data from the updated local care plan.

9. The system of claim 1, wherein execution of the instructions implements the application for:
automatically comparing standard care plans provided by at least two clinical content providers; and
creating a single standard care plan from at least two standard care plans that share matching care plan-defining attributes, the single standard care plan comprising identification numbers from the at least two clinical content providers.

10. The system of claim 1, wherein execution of the instructions implements the application for amending the library of oncology care plans with one care plan based on the updated local care plan.

11. A method of managing oncology care plans, the method comprising:
retrieving a standard care plan from an electronically stored library of oncology care plans provided by one or more clinical content providers;
receiving, from a user, a modification to the standard care plan;
generating a local care plan comprising the standard care plan and the modification to the standard care plan;
retrieving, from the electronically stored library of oncology care plans, an updated standard care plan, the updated standard care plan comprising one or more updates to the standard care plan provided by the one or more clinical content providers; and
automatically generating an updated local care plan, the updated local care plan comprising the updated standard care plan and the modification to the standard care plan.

12. The method of claim 11, wherein the modification to the standard care plan comprises at least one of an addition, a change, or a deletion of one or more attributes of the standard care plan.

13. The method of claim 11, wherein the modification to the standard care plan is based on at least one of geographic location, availability of treatment options, or a clinical factor.

14. The method of claim 11, further comprising activating the updated local care plan.

15. The method of claim 11, further comprising:
retrieving an electronic medical record (EMR) from a data storage server, the EMR comprising information about a patient's clinical presentation; and
automatically identifying the updated local care plan as being a suitable care plan for the patient, based on the patient's clinical presentation.

16. The method of claim 15, further comprising:
selecting the updated local care plan for treating the patient; and
determining a pathway adherence for the updated local care plan, the pathway adherence representing a correlation between the updated local care plan and an opinion from an expert regarding an appropriate treatment for the patient.

17. The method of claim 15, further comprising determining a pathway deviation for the patient, the pathway deviation representing a correlation between the updated local care plan and an actual treatment given to the patient.

18. The method of claim 15, further comprising updating the EMR with data from the updated local care plan.

19. The method of claim 11, further comprising:
automatically comparing standard care plans provided by at least two clinical content providers; and
creating a single standard care plan from at least two standard care plans that share matching care plan-defining attributes, the single standard care plan comprising identification numbers from the at least two clinical content providers.

20. The method of claim 11, further comprising amending the library of oncology care plans with one care plan based on the updated local care plan.
